(19) United States
(12) Patent Application Publication
(10) Pub. No.: US 2018/0247204 A1
(43) Pub. Date: Aug. 30, 2018

(54) PLATFORM FOR DECISION MAKING, DATA MANAGEMENT, ANALYSIS, AND EVALUATION

(71) Applicant: CSE Partner LLC, Rye, NY (US)

(72) Inventor: Cheryl EINHORN, Rye, NY (US)

(21) Appl. No.: 15/905,357

(22) Filed: Feb. 26, 2018

Related U.S. Application Data
(60) Provisional application No. 62/463,131, filed on Feb. 24, 2017.

(51) Int. Cl. G06N 5/02; G06F 17/30

(52) U.S. Cl. CPC G06N 5/02; G06F 17/30477

(57) ABSTRACT

Disclosed herein is a method for solving complex problems and managing, collecting, storing, analyzing, and evaluates user research and decision making data. More particularly, exemplary embodiments of the present invention relates to a computer and software system for decision making that includes data collection, management, analysis, and evaluation. Exemplary embodiments of the present invention further relates to a computer-readable storage medium containing computer-executable instructions for managing, analyzing, and evaluating data.

### CROSS REFERENCE TO RELATED APPLICATIONS

This application claims the benefit of U.S. provisional application No. 62/463,131, which was filed on Feb. 24, 2017, and is incorporated herein by reference in its entirety.

### FIELD OF INVENTION

Exemplary embodiments of the present invention relates to a series of digital education modules housed on a software platform that manages and analyzes data. More particularly, exemplary embodiments of the present invention relate to an education tool for decision making. Exemplary embodiments of the present invention further relates to a computer-readable storage medium containing computer-executable instructions for managing and analyzing data.

### BACKGROUND OF THE INVENTION

The present invention relates to a computer system and method for making complex decisions. The increasing advances in Artificial Intelligence (AI) techniques offers a tremendous opportunity to advance decision making. These systems rely on knowledge engineers to input rules, formulate them, and use them to answer various questions that require expertise.

The autonomic computing promoted by IBM since 2000 mimics the executive functions of a human brain: monitoring, analyzing, planning and executing, but it is unable to generate intelligence. Around the same time, machine learning AI techniques such as artificial neural net and symbolic computing perhaps have limited progress but no breakthrough to generate intelligence. To generate answers, IBM's Watson inputs contents of 0.2 billion webpages, including the entire Wikipedia. It is true that Watson made a great stride in building a semantic network to hold the knowledge, but still Watson is unable to generate truly creative intelligence. Nevertheless, in 2012 IBM merged Watson expert system into its Smart Cloud products, co-named PureSystems and Expert Integrated Systems. This modern expert system is able to assist cloud computing to deploy complex resources and optimize workload. It is however unable to generate intelligence for self-improvement. Likewise, other AI takes advantage of intelligent method to observe, decide, and act (ODA) for the performance of multi-core computer systems. These systems utilize a pre-set method to optimize performance, which is not a creative self-improvement.

### SUMMARY OF THE INVENTION

In one embodiment, the present invention provides a computer system for educating, collecting, maintaining and analyzing decision making data.
(a) instructions to guide a user to input information to analyze and create a protocol to direct the user about cognitive biases,
(b) instructions to guide a user to input information about relative advantages and disadvantages related to collection and analysis of data,
(c) instructions for identifying absolute research targets,
(d) instructions for identifying related sources of information that are tangentially associated with the absolute research targets,
(e) instructions for identifying sources and query-based input to analyze data,
(e) instructions for questioning, evaluating and analyzing both confirming and disconfirming data and conclusions,
(f) instructions for identifying flaws in information and thinking; and
(g) a series of digital modules that executes the computer-executable instructions stored in the memory.

In some embodiments of the computer system, the cognitive biases in part (a) is Planning Fallacy, Confirmation Bias, Optimism Bias, Projection Bias, Social Proof, Salience Bias, Narrative Bias, Loss Aversion, Relativity Bias, Authority Bias, Liking Bias, Scarcity Bias, or combinations thereof.

In some embodiments of the computer system, the computer system further comprising a data management system for collecting and organizing information about the absolute research targets in part (c).

In some embodiments of the computer system, the information about the absolute research targets is qualitative information, quantitative information, or both.

In some embodiments the computer system, the information about the absolute research targets comprises numerical data about the absolute research targets, websites of the absolute research targets, press releases from the absolute research targets, leadership and management information about the absolute research targets, research reports published by the absolute research targets, or combinations thereof.

In some embodiments the computer system, the computer system further comprising a data management system for collecting and organizing information from the related sources in part (d).

In some embodiments of the computer system, the related sources of information suggest, for example, (d) comprises databases for legal cases, a database of medical journal articles, or news articles, and more and combinations thereof.

In some embodiments of the computer system, the output of the computer system is one or more individualized profiles for a user, for example, a user's decision making archetype.

In some embodiments of the computer system, the profile for a user is a template that maps all data collected, analysis decision points and provides suggested actions steps for further research/analysis.

In another embodiment, the present invention provides a method for managing and analyzing data comprising:
(a) guiding a user to input information to analyze and create a protocol to direct the user about cognitive biases;
(b) guiding a user to input information about relative advantages and disadvantages related to collection and analysis of data;
(c) identifying absolute research targets;
(d) identifying related sources of information that are tangentially associated with the absolute research targets;
(e) identifying sources and query-based input to analyze data;
(e) questioning, evaluating and analyzing both confirming and disconfirming data and conclusions; and
(f) identifying flaws in information and thinking.

In some embodiments of the method, the cognitive biases in part (a) is Planning Fallacy, Confirmation Bias, Optimism Bias, Projection Bias, Social Proof, Salience Bias, Narrative Bias, Loss Aversion, Relativity Bias, Authority Bias, Liking Bias, Scarcity Bias, or combinations thereof.

In some embodiments of the method, the method further comprising a data management system for collecting and organizing information about the absolute research targets in step (c).

In some embodiments of the method, the information about the absolute research targets is qualitative information, quantitative information, or both.

In some embodiments the method, the information about the absolute research targets comprises numerical data about the absolute research targets, websites of the absolute research targets, press releases from the absolute research targets, leadership and management information about the absolute research targets, research reports published by the absolute research targets, or combinations thereof.

In some embodiments the method, the method further comprising a data management system for collecting and organizing information from the related sources in step (d).

In some embodiments of the method, the related sources of information suggest, for example, (d) comprises databases for legal cases, a database of medical journal articles, or news articles, and more and combinations thereof.

In some embodiments of the method, the output of the computer system is one or more individualized profiles for a user, for example, a user's decision making archetype.

In some embodiments of the method, the profile for a user is a template that maps all data collected, analysis decision points and provides suggested actions steps for further research/analysis.

In some embodiments of the method, the method provides one or more individualized profiles for a user.

In some embodiments of the method, the profile for a user is a template that maps all data collected, analysis, evaluation, and decision points.

In yet another embodiment, the present invention provides a computer-readable storage medium containing computer-executable instructions for managing and analyzing data, the computer-executable instructions comprise of:
(a) instructions to guide a user to input information to analyze and create a protocol to direct the user about cognitive biases,
(b) instructions to guide a user to input information about relative advantages and disadvantages related to collection and analysis of data,
(c) instructions for identifying absolute research targets,
(d) instructions for identifying related sources of information that are tangentially associated with the absolute research targets,
(e) instructions for identifying sources and query-based input to analyze data,
(e) Instructions for questioning, evaluating and analyzing both confirming and disconfirming data and conclusions,
(f) Instructions for identifying flaws in information and thinking.

In some embodiments of the computer-readable storage medium, the cognitive biases in part (a) is Planning Fallacy, Confirmation Bias, Optimism Bias, Projection Bias, Social Proof, Salience Bias, Narrative Bias, Loss Aversion, Relativity Bias, Authority Bias, Liking Bias, Scarcity Bias, or combinations thereof.

In some embodiments of the computer-readable storage medium, the storage medium further comprising a data management system for collecting and organizing information about the absolute research targets in part (c).

In some embodiments of the computer-readable storage medium, the information about the absolute research targets is qualitative information, quantitative information, or both.

In some embodiments the computer-readable storage medium, the information about the absolute research targets comprises numerical data about the absolute research targets, websites of the absolute research targets, press releases from the absolute research targets, leadership and management information about the absolute research targets, research reports published by the absolute research targets, or combinations thereof.

In some embodiments the computer-readable storage medium, the storage medium further comprising a data management system for collecting and organizing information from the related sources in part (d).

In some embodiments of the computer-readable storage medium, the related sources of information suggest, for example, (d) comprises databases for legal cases, a database of medical journal articles, or news articles, and more and combinations thereof.

In some embodiments of the computer-readable storage medium, the computer-executable instructions contained in the storage medium when executed outputs one or more individualized profiles for a user, for example, a user's decision making archetype.

In some embodiments of the computer-readable storage medium, the profile for a user is a template that maps all data collected, analysis decision points and provides suggested actions steps for further research/analysis.

### BRIEF DESCRIPTION OF THE DRAWING

FIG. 1 depicts an exemplary, non-limiting flow diagram illustrating a method for managing, analyzing, and evaluating data.

FIG. 2 depicts an exemplary, non-limiting flow diagram illustrating a method for managing, analyzing, and evaluating data.

FIG. 3 illustrates a first exemplary, non-limiting module of the invention useful in for example decision making.

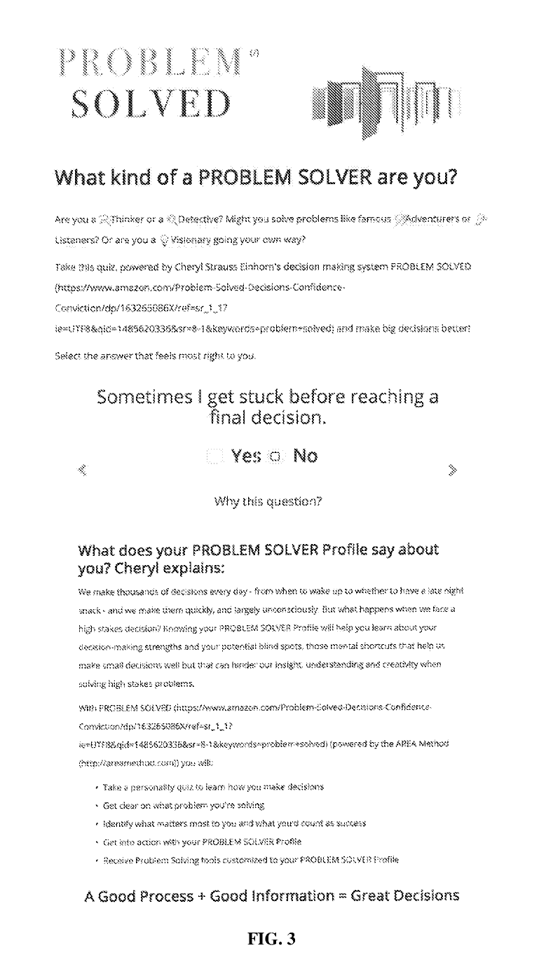

FIG. 4 illustrates a second exemplary, non-limiting module of the invention useful in for example decision making.

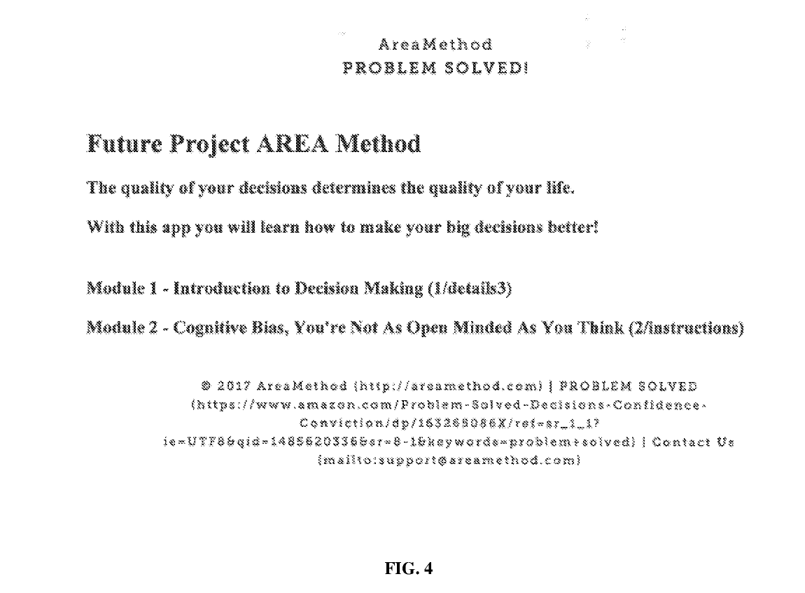

FIG. 5 illustrates a third exemplary, non-limiting module of the invention useful in for example decision making.

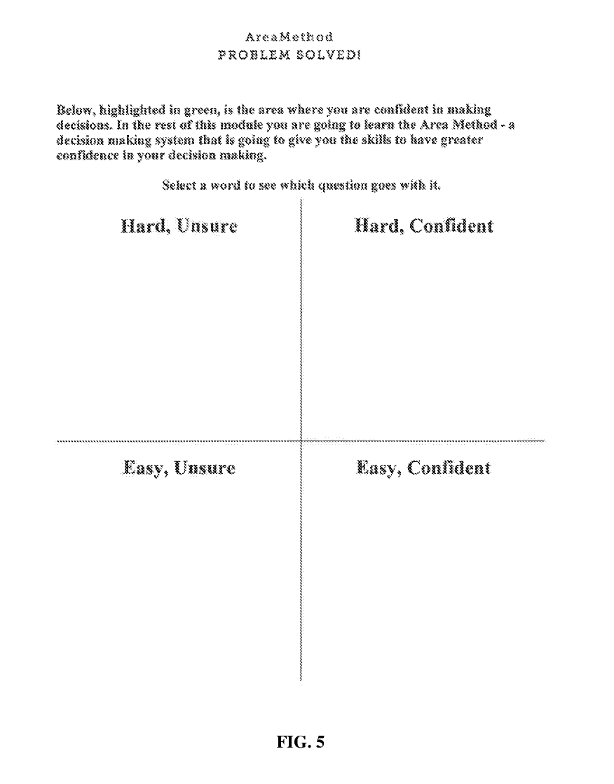

### DETAILED DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the relevant art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

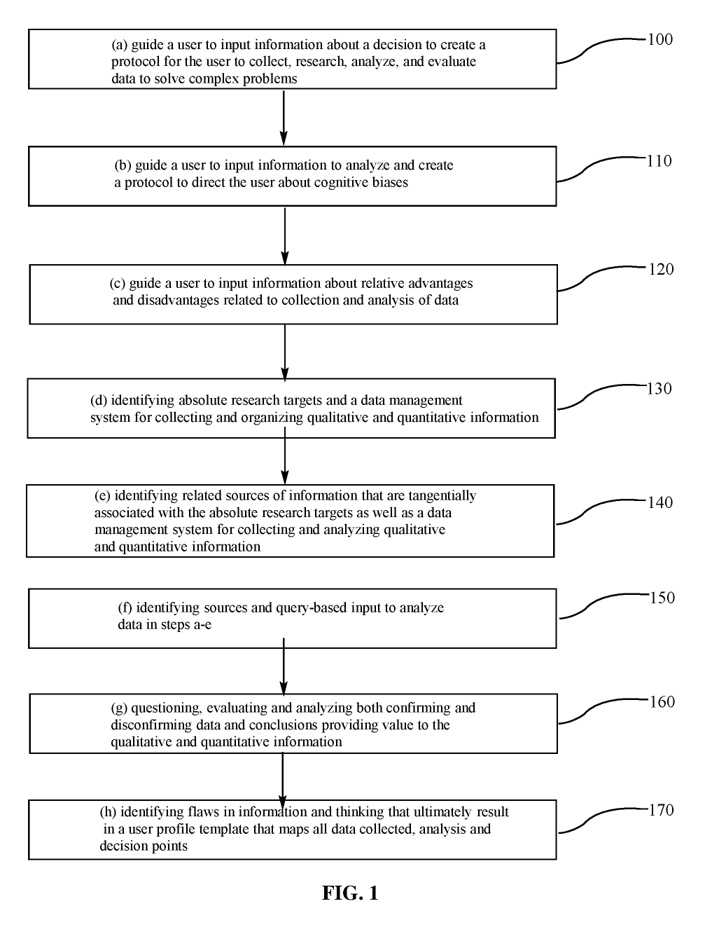

FIG. 1 depicts An exemplary flow diagram illustrating a method for educating, managing, storing and analyzing data that provides one or more individualized profiles for a user.

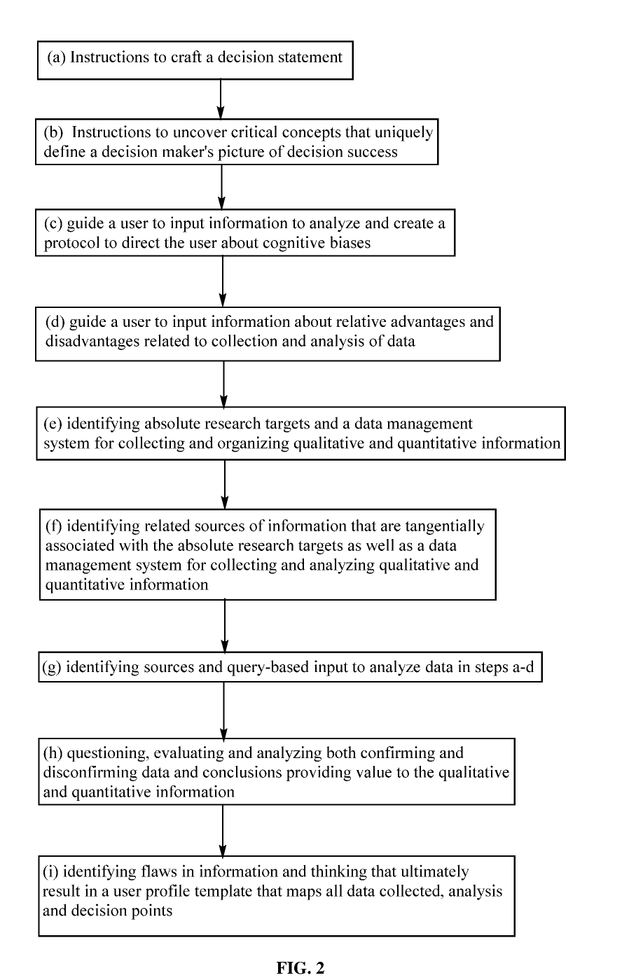

FIG. 2 depicts an exemplary flow diagram illustrating a method for educating, managing, storing and analyzing data that provides one or more individualized profiles for a user, which adds the added steps of providing instructions to craft a decision statement and providing instructions to uncover critical concepts that uniquely define a decision maker's picture of decision success.

In process 100, the method guides a user to input information about a decision to create a protocol for the user to collect, research, analyze, and evaluate data to solve complex problems

In process 110, the method guides a user to input information to analyze and create a protocol to direct the user about cognitive biases.

In process 120, the method guides a user to input information about relative advantages and disadvantages related to collection and analysis of data.

In process 130, the method identifies absolute research targets and a data management system for collecting and organizing qualitative and quantitative information.

In process 140, the method identifies related sources of information that are tangentially associated with the absolute research targets as well as a data management system for collecting and analyzing qualitative and quantitative information.

In process 150, the method identifies sources and query-based input to analyze data in processes 110, 120, 130, and 140.

In process 160, the method questions, evaluates and analyzes both confirming and disconfirming data and conclusions providing value to the qualitative and quantitative information.

In process 170, the method identifies flaws in information and thinking that ultimately result in a user profile template that maps all data collected, analysis and decision points.

In some embodiments, the present invention provides a protocol to direct a user about cognitive biases. Cognitive biases limit us as objective thinkers and observers. When we face high-stakes decisions, we don't want to use the same old well-worn pathways. We want to be more expansive in our thinking and open new channels to exercise true objectivity and creativity. Below is a list of common cognitive biases that can impede good decision making, but that the present invention can help a user overcome.

In some embodiments, the cognitive bias is Planning Fallacy. Planning Fallacy is our tendency to underestimate the time, costs, and risks of completing a task, even though we've previously experienced similar tasks. Time management is a significant issue in research and decision-making. We may miss out on an opportunity because we've underestimated how long it takes us to conduct our research. In some embodiments, the present invention is designed to reduce planning fallacy over time by repeating a consistent process, a user will also reduce the likelihood of poorly planning time.

In some embodiments, the cognitive bias is Confirmation Bias. Confirmation Bias refers to a form of selective thinking in which we seek out and overvalue information that confirms our existing beliefs, while neglecting or undervaluing information that is contradictory to our existing beliefs. It is related to commitment and consistency bias where we behave in a way that validates our prior actions. It is also related to the incentive bias where we adapt our views to what benefits us. A confirmation bias may lead us to interpret information falsely because it conflicts with our prior views and beliefs. Confirmation biases can lead to overconfidence in personal beliefs, even in the face of contrary evidence. In business and in our personal lives, it can lead to extremely poor (and costly) decisions. In some embodiments, the present invention was created specifically to slow our disposition to make assumptions and pass judgment while enabling us to better assess the incentives of others.

In some embodiments, the cognitive bias is Optimism Bias. Optimism Bias is a bias in which someone's subjective confidence in their judgments, or in the judgments of others, is reliably greater than their objective accuracy. In some embodiments, the present invention is designed to reduce optimism bias by guiding a user to read numbers before narrative will counter this bias.

In some embodiments, the cognitive bias is Projection Bias. Projection Bias is our tendency to project our thoughts and beliefs onto others and assume that they are wired the same way we are. This can lead to “false consensus bias,” which not only assumes that other people think like we do, but that they reach the same conclusions that we have reached. In short, this bias creates a false consensus or sense of confidence. In some embodiments of the present invention, a user will be using a source-based methodology that is structured to heighten a user's awareness of his own thinking while focusing the user clearly on other people's viewpoints.

In some embodiments, the cognitive bias is Social Proof. Social Proof refers to our tendency to think and believe what the people around us think and believe. We see ourselves as individuals but we actually run in herds—large or small, bullish or bearish. In some embodiments, the present invention provides a natural defense against this bias because it is structured process and it encourages a user to do his own work, broken down into discrete and manageable research pieces.

In some embodiments, the cognitive bias is Salience Proof. Salience Bias refers to the tendency to overweight evidence that is recent or vivid. In some embodiments, the present invention is designed to reduce salience bias by ensuring a user considers all information, putting evidence into context, and challenging the user to focus on significant issues, as opposed to salient ones.

In some embodiments, the cognitive bias is Narrative Bias. Narrative Bias is our preference for stories to data. Narratives are crucial to how we make sense of reality. They help us to explain, understand and interpret the world around us. They also give us a frame of reference we can use to remember the concepts we take them to represent. However, our inherent preference of narrative over data often limits our understanding of complicated situations. In some embodiments, the present invention is designed to reduce narrative bias by beginning with numbers and data, encouraging a user to distill and analyze information, and directing the user to create multiple narratives for a research target's.

In some embodiments, the cognitive bias is Loss Aversion. Empirical estimates find that losses are felt almost two-and-a-half times as strongly as gains. This is Loss Aversion. In some embodiments, the present invention is designed to reduce loss aversion by asking a user to withhold judgment and consider scenarios that at first might not appear likely. In some embodiments, the present invention also provides guidance to consider failure before making decision to further battle this bias. In some embodiments, the present invention also provides guidance to counteract failure.

In some embodiments, the cognitive bias is Relativity Bias. Relativity Bias inhibits our ability to objectively assess information based upon an over-dependence on comparisons. In some embodiments, the present invention will focus a user on what could go wrong with comparisons so that it won't.

In some embodiments, the cognitive bias is Authority Bias. Authority Bias refers to our natural inclination to follow and to believe in authority figures. The present invention is designed to reduce authority bias by separating Absolute and Relative information to counter this bias. If the information we receive from an authority figure conflicts with information we have received from another source, we will identify the dissonance.

In some embodiments, the cognitive bias is Liking Bias. Liking Bias is if you like someone or something, you will interpret data in their favor. We tend to like people who are like us, or have qualities that we admire. This bias is closely related to the reciprocity bias in which we tend to want to reciprocate a favor that someone has done for us. In some embodiments, the present invention is designed to reduce liking bias by separating Absolute information from information that you receive from other people.

In some embodiments, the cognitive bias is Scarcity Bias. Scarcity Bias refers to our tendency to covet things we believe are scarce, sometimes irrationally. In some embodiments, the present invention is designed to reduces scarcity bias by directing a user to closely focus on checking his thinking.

In some embodiments, the cognitive bias is a combination of two or more of Planning Fallacy, Confirmation Bias, Optimism Bias, Projection Bias, Social Proof, Salience Bias, Narrative Bias, Loss Aversion, Relativity Bias, Authority Bias, Liking Bias, and Scarcity Bias.

In some embodiments, the invention encompasses an analytic method for high-stakes decisions that deserve time and attention.

In some embodiments, the system and method of the invention provide both stability and maneuverability to the decision making process.

In some embodiments, the system and method of the invention provides calculated pauses and periods of deceleration that enable the user to consolidate knowledge. In certain embodiments, the quality research and decision making process provides depth, flexibility and creativity. Particularly, the system and method's pauses work as ‘strategic stops’ during and after each part of research. In certain embodiments, the pauses enable learning, prevent from going off course, and provide a clear record of work at each stage. In other embodiments, the pauses assist in high stakes decision and identify what is most critical to the outcome.

In other embodiments, Critical Concepts (CC's) are things the user needs to have occur in the outcome of the decision to know that the decision has succeeded. In certain embodiments, Critical Concepts will vary. Different decision makers will have different time horizons in which to make their decisions, different personalities, and different goals. Two people looking at the same data may well have different CCs and may make entirely different decisions.

In other embodiments, strategic pauses (called Cheetah Pauses) will help to continually refine and re-articulate your CC's based upon what is learned and synthesized from research. They are an integral part of the process. The goal of the CC's is to ensure focus on making a decision that uniquely addresses the user's vision of success. Taking the time to identify what's critical—your CC's—is the foundation to my analytical method.

In other embodiments, good methodology and a clear sense of outcome of the decision is necessary. Whether you're making a critical professional or personal decision, the system and method is an equitable tool that provides a step-by-step framework that focuses work and thinking on Critical Concepts.

In other embodiments, the method and system of the invention guide the users to make smarter, better decisions by improving upon classic research and decision making pedagogy in four important ways:
1. recognizes that research is a fundamental part of decision making.
2. solves the tricky problems of mental myopia, namely of assumption, bias and judgment, through its construction as a perspective taking process.
3. addresses the critical component of timing head-on so that you have time for calculated and directed reflections that promote insight, slowing down to speed up the efficacy of your work.
4. provides a clear, concise and repeatable process that works as a feedback loop in part or in its entirety.

In some embodiments, the present invention includes identifying absolute research targets. Every decision is impacted by a business or organization, and a user will make a better decision if he is comfortable and familiar with this entity at the center of his research decision—the Absolute target.

In some embodiments, the present invention includes collecting and organizing information about the absolute research targets. In some embodiment, the information is numerical data provided by the targets. In some embodiment, the information is collected from the target's website. In some embodiment, the information is communicated officially through press releases. In some embodiment, the information is about the leadership and management of the target. In some embodiments, the information is research, policy reports, or proposals on an issue published by the target.

In some embodiments, the present invention includes identifying related sources of information that are tangentially associated with the absolute research targets. In some embodiments, the present invention includes collecting and organizing information from the related sources. In some embodiments, the related source of information is from literature reviews and databases. In some embodiment, the literature review and databases will be specific to the user's decision, such as from a legal database like Lexus/Nexus® or others. In some embodiments, the related source of information is a database of, for example, medical journal articles. In some embodiments, the database of medical journal articles is Medline. In some embodiments, the related source of information is, for example, a database of news articles. In some embodiments, the database of news articles is National Newspaper Index.

In some embodiments, the present invention includes a computer system. The computer system may be digital modules, a server computer, a client computer, a personal computer (PC), a tablet PC, a set-top box (STB), a personal digital assistant (PDA), a cellular telephone, a web appliance, an application, a network router, switch or bridge, or any machine capable of executing a set of instructions (sequential or otherwise) that specify actions to be taken by that machine.

In some embodiments, the present invention includes a computer system comprising a processor that executes instructions stored in the memory. The processor may be a Central Processing Unit (CPU), a microprocessor, an electronic circuit, an Integrated Circuit (IC) or the like. Alternatively, the processor can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC).

In some embodiments, the present invention includes a memory for storing computer-executable instructions. The memory may be persistent or volatile. For example, the memory can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like.

In some embodiments, the present invention includes a computer-readable storage medium. The term “computer-readable storage medium” should be taken to include a single medium or multiple media (e.g., a centralized or distributed database, and/or associated caches and servers does this cover digital modules and software platforms?) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. Examples of machine or computer-readable media include but are not limited to recordable type media such as volatile and non-volatile memory devices, a magnetic storage device such as a tape, a floppy disk, a hard disk, storage area network (SAN), a network attached storage (NAS), optical disks such as a CD, a DVD, or a laser disk, a semiconductor storage device such as Flash device, memory stick, or the like, and transmission type media such as digital and analog communication links.

In some embodiments, the present invention includes educational tools, a data management system for collecting, analyzing, managing, storing, and organizing information. In some embodiments, the data management system is a database management system (DBMS), for example but not limited to, Oracle, DB2, Microsoft Access, Microsoft SQL Server, PostgreSQL, MySQL, FileMaker, etc. The database management system can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

Although embodiments have been described with reference to specific example embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A computer system for decision making, data management and analysis comprising memory storing computer-executable instructions comprising
(a) instructions to guide a user to input information to analyze and create a protocol to direct the user about cognitive biases,
(b) instructions to guide a user to input information about relative advantages and disadvantages related to collection and analysis of data,
(c) instructions for identifying absolute research targets,
(d) instructions for identifying related sources of information that are tangentially associated with the absolute research targets,
(e) instructions for identifying sources and query-based input to analyze data,
(e) instructions for questioning, evaluating and analyzing both confirming and disconfirming data and conclusions,
(f) instructions for identifying flaws in information and thinking; and
A processor that executes the computer-executable instructions stored in the memory.

2. The computer system of claim 1, wherein the cognitive biases in part (a) is Planning Fallacy, Confirmation Bias, Optimism Bias, Projection Bias, Social Proof, Salience Bias, Narrative Bias, Loss Aversion, Relativity Bias, Authority Bias, Liking Bias, Scarcity Bias, or combinations thereof.

3. The computer system of claim 1, further comprising a data management system for collecting and organizing information about the absolute research targets in part (c).

4. The computer system of claim 3, wherein the information about the absolute research targets is qualitative information, quantitative information, or both.

5. The computer system of claim 3, wherein information about the absolute research targets comprises numerical data about the absolute research targets, websites of the absolute research targets, press releases from the absolute research targets, leadership and management information about the absolute research targets, research reports published by the absolute research targets, or combinations thereof.

6. The computer system of claim 1, further comprising a data management system for collecting and organizing information from the related sources in part (d)

7. The computer system of claim 1, wherein the related sources of information in part (d) comprises a database of legal cases, a database of medical journal articles, or a database of news articles, or combinations thereof.

8. The computer system of claim 1, wherein the output of the system is decision making tools and skills that result in aiding in complex decision making.

9. The computer system of claim 8, wherein the profile for a user is a template that maps all data collected, analysis, and provides suggested actions steps for further research/analysis.

10. A method for managing and analyzing data comprising:
(a) guiding a user to input information to analyze and create a protocol to direct the user about cognitive biases;
(b) guiding a user to input information about relative advantages and disadvantages related to collection and analysis of data;
(c) identifying absolute research targets;
(d) identifying related sources of information that are tangentially associated with the absolute research targets;
(e) identifying sources and query-based input to analyze data;
(e) questioning, evaluating and analyzing both confirming and disconfirming data and conclusions; and
(f) identifying flaws in information and thinking.

11. The method of claim 10, wherein the cognitive biases in step (a) is Planning Fallacy, Confirmation Bias, Optimism Bias, Projection Bias, Social Proof, Salience Bias, Narrative Bias, Loss Aversion, Relativity Bias, Authority Bias, Liking Bias, Scarcity Bias, or combinations thereof.

12. The method of claim 10, further comprising a data management system for collecting and organizing information about the absolute research targets in step (c).

13. The method of claim 12, wherein the information about the absolute research targets is qualitative information, quantitative information, or both.

14. The method of claim 12, wherein information about the absolute research targets comprises numerical data about the absolute research targets, websites of the absolute research targets, press releases from the absolute research targets, leadership and management information about the absolute research targets, research reports published by the absolute research targets, or combinations thereof.

15. The method of claim 10, further comprising a data management system for collecting and organizing information from the related sources in step (d).

16. The method of claim 10, wherein the related sources of information in step (d) comprises a database of legal cases, a database of medical journal articles, or a database of news articles, or combinations thereof.

17. A computer-readable storage medium, digital modules and software platform containing computer-executable instructions for managing, storing and analyzing data, the computer-executable instructions comprise of:
(a) instructions to guide a user to input information to analyze and create a protocol to direct the user about cognitive biases,
(b) instructions to guide a user to input information about relative advantages and disadvantages related to collection and analysis of data,
(c) instructions for identifying absolute research targets,
(d) instructions for identifying related sources of information that are tangentially associated with the absolute research targets,
(e) instructions for identifying sources and query-based input to analyze data,
(e) Instructions for questioning, evaluating and analyzing both confirming and disconfirming data and conclusions,
(f) Instructions for identifying flaws in information and thinking.

18. The computer-readable storage medium of claim 17, further comprising instructions for a data management system that collects and organizes information about the absolute research targets in part (c).

19. The computer-readable storage medium of claim 18, wherein information about the absolute research targets comprises numerical data about the absolute research targets, websites of the absolute research targets, press releases from the absolute research targets, leadership and management information about the absolute research targets, research reports published by the absolute research targets, or combinations thereof.

20. The computer-readable storage medium of claim 17, further comprising instructions for a data management system that collects and organizes information from the related sources in part (d).

21. A computer-readable storage medium containing computer-executable instructions for managing and analyzing data, the computer-executable instructions comprise:
(a) instructions to craft a decision statement;
(b) instructions to uncover critical concepts that uniquely define a decision maker's picture of decision success;
(c) instructions to guide a user to input information to analyze and create a protocol to direct the user about cognitive biases;
(d) instructions to guide a user to input information about relative advantages and disadvantages related to collection and analysis of data;
(e) instructions for identifying absolute research targets;
(f) instructions for identifying related sources of information that are tangentially associated with the absolute research targets;
(g) instructions for identifying sources and query-based input to analyze data;
(h) instructions for questioning, evaluating and analyzing both confirming and disconfirming data and conclusions; and
(i) instructions for identifying flaws in information and thinking.

22. A computer system for data management and analysis comprising memory storing computer-executable instructions comprising
(a) instructions to craft a decision statement;
(b) instructions to uncover critical concepts that uniquely define a decision maker's picture of decision success;
(c) instructions to guide a user to input information to analyze and create a protocol to direct the user about cognitive biases;
(d) instructions to guide a user to input information about relative advantages and disadvantages related to collection and analysis of data;
(e) instructions for identifying absolute research targets;
(f) instructions for identifying related sources of information that are tangentially associated with the absolute research targets;
(g) instructions for identifying sources and query-based input to analyze data;
(h) instructions for questioning, evaluating and analyzing both confirming and disconfirming data and conclusions; and
(i) instructions for identifying flaws in information and thinking; and
a processor that executes the computer-executable instructions stored in the memory.
